(19) United States
(12) Patent Application Publication
(10) Pub. No.: US 2010/0161505 A1
(43) Pub. Date: Jun. 24, 2010

(54) ENTERPRISE KNOWLEDGE MANAGEMENT AND SHARING METHOD AND APPARATUS

(76) Inventors: Jonathan Ding, Shanghai (CN); Bo Huang, Shanghai (CN); Wenjie Zhang, Shanghai (CN)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/575,954

(22) PCT Filed: Dec. 22, 2006
(86) PCT No.: PCT/CN06/03532

§ 371 Date: Mar. 23, 2007

(51) Int. Cl. G06Q 99/00; G06Q 10/00; G06F 17/30

(52) U.S. Cl. 705/342; 707/E17.014; 707/776

(57) ABSTRACT

An enterprise knowledge management and sharing system having a plurality of services to facilitate members of an enterprise to create, capture, organize, refine, promote and/or publish knowledge of the enterprise is disclosed and described herein.

### BACKGROUND

1. Technical Field

Embodiments of the present invention are related to the field of data processing, and in particular, to knowledge management and sharing among members of an enterprise.

2. Description of Related Art

Advances in microprocessor, networking and related technologies have let to an explosion of availability of information. A lot of companies/enterprises are managing content within the enterprise using CMS (Content Management System). However, conventional CMS focuses on processing and storing the content, and it does not abstract the content into higher knowledge. For example, for a picture describing the internal structure of a machine X, CMS will provide a process to submit, edit, review and store the picture, but it does not facilitate associating the picture with keywords like “internal structure of X”, neither does it allow readers to do ranking and/or tagging. Resultantly, it is not easy for other members of the enterprise to subsequently find, read and learn about the internal structure of X.

### BRIEF DESCRIPTION OF THE DRAWINGS

FIG. 1 illustrates an overview of an enterprise computing environment having an Enterprise Knowledge Management and Sharing Platform (EKMSP), according to some embodiments of the present invention.

FIG. 2 illustrates an overview of a knowledge management and sharing method, according to some embodiments of the present invention.

FIG. 3 illustrates the EKMSP in further detail, from a front-end/back-end view, according to some embodiments of the present invention.

FIG. 4 illustrates the EKMSP in further detail, from a user services perspective, according to some embodiments of the present invention;

FIG. 5 illustrates a network of EKMSP, according to some embodiments of the present invention.

FIG. 6 is a block diagram of an illustrative computing system suitable for use to practice the present invention, according to some embodiments of the present invention.

### DETAILED DESCRIPTION OF ILLUSTRATIVE EMBODIMENTS

Embodiments of the invention include a knowledge management and sharing platform for knowledge management and sharing among members of an enterprise.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one/various embodiment(s)” is used repeatedly. The phrase generally does not refer to the same embodiment; however, it may. The term “coupled” shall encompass a direct connection, an indirect connection or an indirect communication. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

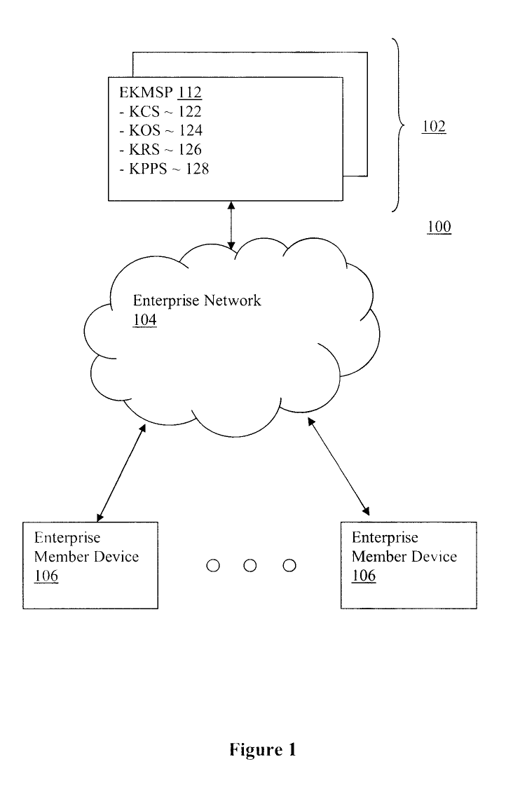

With reference to FIG. 1, there is illustrated an enterprise computing environment of an enterprise, having an Enterprise Knowledge Management and Sharing Platform (EKMSP) of the present invention, according to some embodiments. As illustrated, enterprise computing environment 100 includes one or more servers 102, implementing an EKMSP 112, for members of the enterprise to manage and share knowledge with each other, using enterprise member devices 106, which are coupled to servers 102 via enterprise network 104. In various embodiments, EKMSP 112 includes a number of knowledge management and sharing services 122-128, such as Knowledge Capture/Creation Service (KCS) 122, Knowledge Organization Service (KOS) 124, Knowledge Refinement Service (KRS) 126 and Knowledge Promotion and Publication Service (KPPS) 128. As will be described in more detail below, KCS 122 is adapted to facilitate at least a subset of the members of the enterprise to capture and/or create knowledge within the enterprise, whereas KOS 124 is adapted to facilitate organization of the captured and/or created knowledge within the enterprise. KRS 126, on the other hand, is adapted to facilitate at least the same or another subset of the members of the enterprise to refine the organized knowledge within the enterprise, whereas KPPS 128 is adapted to facilitate promotion and publication of the refined knowledge within the enterprise.

The term “enterprise” as used in the instant description includes but is not limited for profit companies, as well as non-profit organizations. Accordingly, members of an enterprise may be but are not limited to employees, contractors, and volunteers.

Servers 102, except for EKMSP 112 endowed thereon, may be any one of a number of server computing devices known in the art or to be developed. An example server 102 is illustrated in FIG. 6, to be described in more detail below.

Enterprise member devices 106 may be any client devices known in the art or to be developed, including but are not limited to desktop, laptop, tablet and various palm sized hand held computing devices.

Enterprise network 104 represents a private network of the enterprise, which may comprises one or more local area networks. The local area networks may be wired or wireless, in part or in whole, directly coupled to one another or through one or more wide area networks, including virtual private connections tunneled through a public wide area network, such as the Internet.

In various embodiments, KCS 122 may be a selected one of a question and answer service and a wiki-forum, or both. The question and answer service is adapted to enable members of the enterprise to create knowledge by asking and answering questions of each other, whereas the wild-forum is adapted to enable members of the enterprise to create knowledge by raising a topic for discussion among the members.

In various embodiments, the questions asked and/or the subjects raised for discussion may be asked/raised within pre-determined categories. The categories may have owners, who are members of the enterprise, typically members with credibility for the owned categories.

In various embodiments, KCS 122 may include services adapted to facilitate members of the enterprise to capture external knowledge into the enterprise. In various embodiments, the services include one or more mail services, one or more messaging services, and/or one or more web services to enable members of the enterprise to capture external knowledge through various user applications. An example of a mail service is the Small Mail Transfer Protocol service to enable members of the enterprise to capture external knowledge through mail applications, such as Outlook, available from Microsoft Corporation of Redmond, Wash. An example of a messaging service is the Hypertext Transport Protocol service to enable members of the enterprise to capture external knowledge through browser applications, such as Internet Explorer, also available from Microsoft Corporation.

In various embodiments, the knowledge created and captured are primitive and unstructured. In various embodiments, however, the knowledge created and captured are stored in self-describing format, such as Extensible Markup Language (XML). In various embodiments, subsequent comments about the created/captured knowledge are linked to the captured/created knowledge. Additionally, metadata are stored for the knowledge and their associated comments.

In various embodiments, the metadata may include
“version and time” describing the version and time of a knowledge/comment
“author” describing the author of the knowledge/comment
“source” describing where the knowledge/comment come from, e.g. an URL to the original content
“category” describing the category for the knowledge/comment
“tags” describing the member-created keyword(s) for the knowledge/comment
“rank” describing the overall member ranking of the knowledge/comment
“visit counts” describing how many times has the knowledge/comment been visited
“permissions” describing which members are allowed to read/modify the knowledge/comment

In various embodiments, KOS 124 includes services adapted to transform the primitive and unstructured created/captured knowledge into organized knowledge, such as classifying the knowledge into categories, and/or associating knowledge with various keywords.

In various embodiments, KOS 124 includes a heuristics categorizer adapted to automatically categorize created and/or captured knowledge. In various embodiments, KOS 124 also includes a question and answer service to enable selected members of the enterprise to organize the created/captured knowledge by tagging the knowledge to keywords. In various embodiments, the question and answer service is adapted to ask the members “keyword questions” such as “what”, “who”, “how”, “when” and “where”.

In various embodiments, the tagging function of the question and answer service is limited to credible members only. Further, resolution of conflicting or inconsistent tagging may be based on the credibility of the tagging members. For these embodiments, credibility of members are collected and maintained in a database (not shown). In various embodiments, the credibility may be inferred from the enterprise roles and/or positions of the members.

In various embodiments, KRS 126 includes a wiki-forum to enable the members of the enterprise to edit and refine the organized knowledge. In various embodiments, the wiki-forum publishes the organized knowledge by their categories and/or associated keywords. In various embodiments, the wiki-forum may be adapted to enable members to comment and/or propose changes to the knowledge, organization and/or keyword association of the knowledge. The wiki-forum may also be adapted for an owner of the knowledge, selected or all members of the enterprise to accept or reject the proposed changes, re-organization and/or modification of keyword association. For these embodiments, ownership of knowledge is also maintained in a database (not shown). In various embodiments, each knowledge may have multiple owners. Resolution of conflicting or inconsistent comments or edits may also be based on the relative credibility of commentators/editors. In various embodiments, multiple versions of a knowledge may be maintained, allowing rollback if necessary.

In various embodiments, KPPS 128 includes services for promoting and publishing the refined knowledge of the enterprise. In various embodiments, KPPS 128 includes one or more of a question and answer service, a search service, or a Real Simply Syndication (RSS) service. The question and answer service may be adapted to enable members of the enterprise to ask questions in a natural language format and receive answers to their questions. The search service may be adapted to factor into consideration the expertise/credibility of the members who organized and/or refined the knowledge, when ranking the knowledge of answer set for a search, thus improving the quality of the answers provided to the members' search. The RSS service may be adapted to facilitate members of the enterprise to subscribe to topics of interest.

Resultantly, members of the enterprise may be able to manage and share knowledge within the enterprise more effectively.

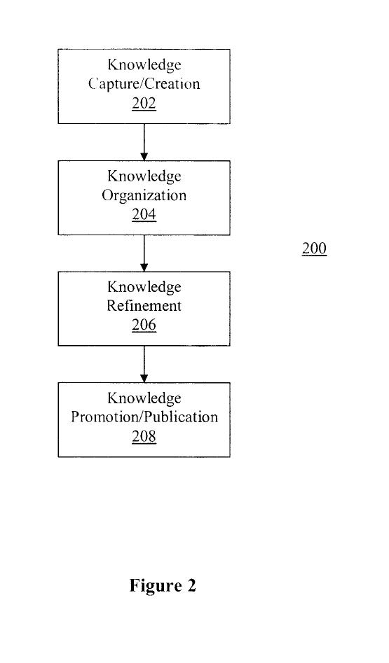

Referring now to FIG. 2, wherein a knowledge management and sharing method, according to various embodiments of the invention is shown. As illustrated and alluded to earlier, method 200 includes initially the creation and/or capturing of knowledge within the enterprise by members of the enterprise, 202. As described earlier, in various embodiments, the creation and/or capturing may be performed through conventional user applications familiar to members of the enterprise, facilitated by the front end services provided by EKMSP 112.

Next, the captured and/or created knowledge within the enterprise are organized, 204. As described earlier, the captured and/or created knowledge may be organized via heuristic categorizer and/or manual categorization or keyword tagging by credible members of the enterprise, leveraging on the expertise of the credible members.

Thereafter, the organized knowledge may be refined, 206. As described earlier, the refinement process may be guided by predetermined keyword questions. The refinement may also favor credible members, leverage on the expertise of the credible members.

Finally, the refined knowledge may be promoted and/or published for consumption by members of the enterprise, 208. Consumption may be facilitated through question and answer, search, RSS and/or other data mining tools/services. Search may rank the search answer set taking into consideration credibility of the members who own and/or refined the knowledge, leveraging on the expertise of the credible members.

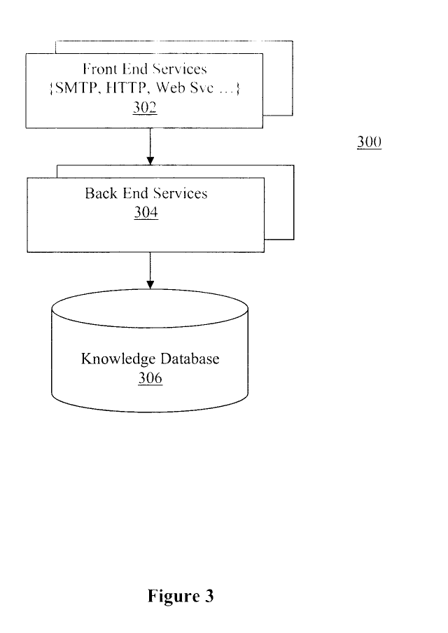

Referring now to FIG. 3, wherein EKMSP 112 of FIG. 1 is illustrated in further detail, from a front-end/back-end view, in accordance with some embodiments. As illustrated, for these embodiments, EKMSP 112 includes a number of front end services 302, a number of back end services 304, and database 306, operatively coupled to each other as shown. Front end services 302 may include the earlier described mail, messaging and web services described, such as SMTP service and HTTP services. Back end services 304 may implement post services, pull services, rank services, and so forth. Together, the front end and back end services 302-304 enable implementation of the earlier described KCS 122, KOS 124, KRS 126 and KPPS 128 services. Database 306 may be employed to store the knowledge, whether they are just created/captured, organized and/or refined, including their associated comments, and metadata for both the knowledge and the comments.

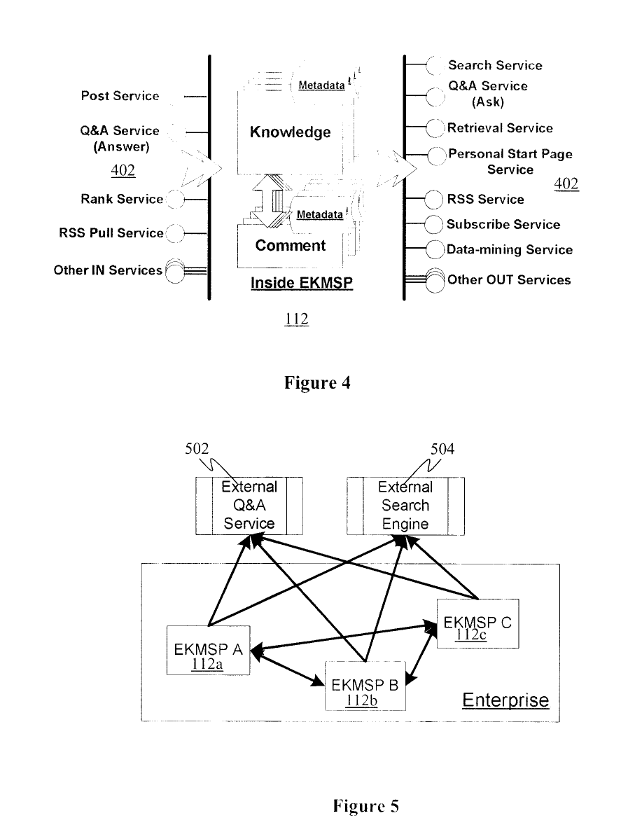

FIG. 4 illustrates EKMSP 112 of FIG. 1 in further detail, from a user service view, in accordance with some embodiments. As illustrated, for the embodiments, EKMSP 112 offer user services 402 such as Post, Question and Answer (Q&A), Ranking, RSS Pull, and so forth, for capturing, creating, organizing and/or refining knowledge. Additionally, for the embodiments, EKMSP 112 offer user services 402 such as Search, Q&A, Retrieval, Personal Start Page, RSS, Subscribe, Data-Mining, and so forth, for retrieving and consuming knowledge maintained in the enterprise.

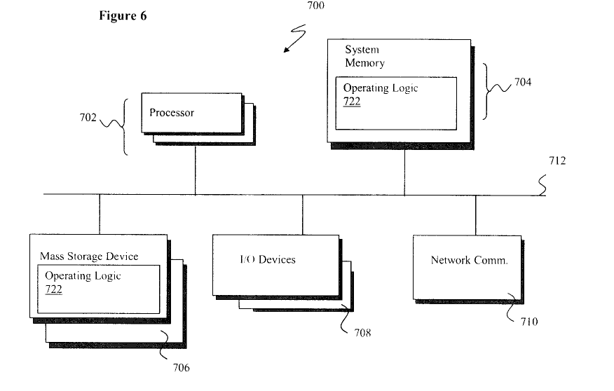

In various embodiments, two or more of the above described EKMSP 112 may be networked together to form a network of EKMSPs 112 to serve an enterprise in managing its knowledge capturing, creation, and sharing. An example of such network is illustrated in FIG. 5. One or more of the networked EKMSPs 112 may be coupled with external Q&A service(s) 502 and/or external Search service(s) 504 to serve the enterprise.

FIG. 6 illustrates an example computer system suitable for use as a server implementing the EKMSP of FIG. 1 in whole or in part, in accordance with various embodiments of the present invention. As shown, computing system 700 includes one or more processors 702, and system memory 704. Additionally, computing system 700 includes mass storage devices 706 (such as diskette, hard drive, CDROM and so forth), input/output devices 708 (such as keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 may be employed to store a working copy and a permanent copy of the programming instructions implementing the earlier described services 122-128 of EKMSP 112, including front end and back end services 302-304, herein collectively denoted as instructions 722. The various components may be implemented as assembler instructions supported by processor(s) 702 or high level languages, such as C, that can be compiled into such instructions.

The permanent copy of the programming instructions may be placed into permanent storage 706 in the factory, or in the field, through, for example, a distribution medium (not shown), such as a compact disc (CD), or through communication interface 710 (from a distribution server (not shown)). A distribution CD may include all or portions of the implementing instructions of services 122-128 of EKMSP 112, including front end and back end services 302-304.

The constitution of these elements 702-712 are known, and accordingly will not be further described.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. An enterprise knowledge management and sharing apparatus, comprising:
at least a selected one of a knowledge capturing service or a knowledge creation service to facilitate at least one of capturing and creating of knowledge within the enterprise by at least a first subset of members of an enterprise;
a knowledge organization service operatively coupled to the at least one knowledge capturing or knowledge creation services to organize the captured or created knowledge within the enterprise;
a knowledge refining service operatively coupled to the knowledge organization service to facilitate refining the organized knowledge within the enterprise by at least a second subset of members of the enterprise; and
a knowledge promotion and publication service operatively coupled to the knowledge refining service to promote and publish the refined knowledge within the enterprise for sharing among members of the enterprise.

2. The apparatus of claim 1, wherein the knowledge capturing service comprises a service to facilitate a member of the enterprise to capture knowledge within the enterprise from content consumed by the member using a browser.

3. The apparatus of claim 1, wherein the knowledge creation service comprises a selected one of a question and answer service and a combined wiki-forum service within the enterprise.

4. The apparatus of claim 1, wherein at least one of the knowledge capturing and creation services stores the captured or created knowledge within the enterprise in a self-describing data format.

5. The apparatus of claim 1, wherein the knowledge organizing service comprises at least a selected one of a categorizer configured to automatically categorize the captured or created knowledge within the enterprise, and a tagging service to facilitate members to tag the captured or created knowledge within the enterprise.

6. The apparatus of claim 1, wherein the knowledge refining service comprises a combined wiki-forum service within the enterprise to facilitate members of the enterprise to comment and/or edit the organized knowledge within the enterprise.

7. The apparatus of claim 1, wherein the knowledge promotional and publication service comprises at least a selected one of a question and answer service, a search service, or a syndication service.

8. An enterprise knowledge management and sharing method comprising:
capturing or creating knowledge within an enterprise by at least a first subset of a plurality of members of the enterprise;
organizing and/or refining the captured or created knowledge within the enterprise by at least a second subset of the plurality of members of the enterprise, taking into consideration credibility of the organizing and/or refining members; and
promoting and publishing the organized and/or refined knowledge within the enterprise for sharing among the members of the enterprise.

9. The method of claim 8, wherein said creating comprises creating knowledge through at least a selected one of question and answer, or a forum discussion.

10. The method of claim 8, wherein said capturing comprises capturing external knowledge into the enterprise.

11. The method of claim 8, wherein said organizing and/or refining comprises automatically categorizing the captured or created knowledge within the enterprise into knowledge of a plurality of categories.

12. The method of claim 8, wherein said organizing and/or refining comprises facilitating a subset of the members of the enterprise to tag the captured or created knowledge within the enterprise, and resolving conflicting or inconsistent tagging in favor of tagging by members of the enterprise with higher credibility.

13. The method of claim 8, wherein said organizing and/or refining comprises facilitating a subset of the members of the enterprise to edit the captured or created knowledge within the enterprise, and resolving conflicting or inconsistent editing in favor of editing by members of the enterprise with higher credibility.

14. The method of claim 8, wherein said organizing and/or refining comprises tracking different versions of knowledge, and facilitating selective rollback of a knowledge from a later version to an earlier version.

15. The method of claim 8, wherein said promoting and/or publishing comprises facilitating a subset of the members of the enterprise to ask questions, search, or subscribe to the refined knowledge.

16. An enterprise system, comprising:
a plurality of client devices, each including at least a selected one of a plurality of office applications, for use by a corresponding plurality of members of an enterprise having the enterprise system; and
one or more servers coupled to the plurality of client devices, having a knowledge management and sharing service including a plurality of interfacing services to interface with the plurality of office applications to enable the members of the enterprise to capture and/or create knowledge within the enterprise, organize and/or refining the captured or created knowledge within the enterprise, and to promote and publish the organized and/or refined knowledge within the enterprise, using the plurality of office applications.

17. The system of claim 16, wherein the plurality of office applications comprise an email application, and the interface services comprise a mail interface service configured to enable a member of the enterprise to capture or create knowledge within the enterprise by sending an email containing the knowledge to the one or more servers.

18. The system of claim 16, wherein the plurality of office applications comprise a generic browser application, and the interface services comprises a hypertext transmission service configured to enable a member of the enterprise to capture knowledge within the enterprise by sending selected content displayed by the generic browser application to the one or more servers.

19. The system of claim 16, wherein the plurality of office applications comprise a document editing application, and the interface services comprises a web service configured to enable a member of the enterprise to capture or create knowledge within the enterprise by sending selected content of a document to the one or more servers

20. The system of claim 16, wherein the plurality of office applications comprise one or more of an email application, a generic browser application or a document editing application.

21. The system of claim 16, wherein the plurality of interfaces comprise one or more of a mail services, a hypertext transmission service, or a document editing application.

22. The system of claim 16, further comprising another one or more servers coupled to the plurality of client devices and the one or more servers, having another knowledge management and sharing service, similarly constituted as the knowledge management and sharing service, to cooperate with the knowledge management and sharing service to enable the members of the enterprise to capture and/or create knowledge within the enterprise, organize and/or refining the captured or created knowledge within the enterprise, and to promote and publish the organized and/or refined knowledge within the enterprise, using the plurality of office applications.

23. An article of manufacture comprising
a machine-readable medium; and
a plurality of programming instructions stored thereon, which when executed by a server, implements on the server a combined Wiki-Forum for an enterprise knowledge management and sharing system (EKMSS) for members of an enterprise having the EKMSS to create, categorize and refine knowledge of the enterprise, within the enterprise.

24. The article according to claim 23, wherein the Wiki-Forum stores the created knowledge within the enterprise in a self-describing data format.

25. The article according to claim 23, wherein the instructions, when executed by a server, also implements a question and answer service for the EKMSS for members of the enterprise having the EKMSS to create, categorize and refine knowledge of the enterprise, within the enterprise.

26. The article according to claim 23, wherein the instructions, when executed by a server, also implements at least a selected one of a categorizer configured to automatically categorize the captured or created knowledge within the enterprise, and a tagging service to facilitate members to tag the captured or created knowledge within the enterprise.

27. The article according to claim 23, wherein the instructions, when executed by a server, also implements at least a selected one of a post service, a question and answer service, or a rank service.

28. The article according to claim 23, wherein the instructions, when executed by a server, also implements at least a selected one of a search service, a question and answer service, a retrieval service, a personal start page service, a subscribe service or a data mining service.
